(19) United States
(12) Patent Application Publication
(10) Pub. No.: US 2018/0262380 A1
(43) Pub. Date: Sep. 13, 2018

(54) SYSTEMS, METHODS AND ALGORITHMS FOR RECEIVERS OF DIGITALLY MODULATED SIGNALS

(71) Applicant: Omar Artemi Yeste Ojeda, Gordonsville, VA (US)

(72) Inventor: Omar Artemi Yeste Ojeda, Gordonsville, VA (US)

(21) Appl. No.: 15/457,903

(22) Filed: Mar. 13, 2017

(51) Int. Cl. H04L 27/26

(52) U.S. Cl. CPC H04L 27/2662; H04L 27/2649

(57) ABSTRACT

A system and method are disclosed to extract the sequence of symbols of a digitally modulated signal, which jointly recover the symbol synchronism, equalize the transmission channel and mitigate interfering signals. In addition, an algorithm is disclosed to adaptively update the response of finite impulse response filters which recursively computes the filter taps every N samples of the input signal, where N is the ratio between the symbol rate and the sampling rate.

### BACKGROUND OF THE INVENTION

### 1. Field of the Invention

The present invention is directed to systems and methods of reception of a digitally modulated signal, more specifically, the invention is directed to systems, methods and algorithms for joint channel equalization, interference mitigation, and symbol synchronization and estimation in receivers of digitally modulated signals.

### 2. Description of Related Art

Digital signal modulation is used by many communications systems to transmit any sort of information in a digital format. Optimal receivers need to perform several operations on the received signal in order to retrieve the embedded digital information. Among such tasks, there are channel equalization, symbol synchronization and symbol estimation. Additionally, many receivers incorporate one or various means to mitigate potential signals that may perturb an accurate extraction of the information in the signal of interest. Commonly, these tasks are carried out independently by means of dedicated systems, which increases the amount of dedicated resources and cannot perform as well as when these tasks are carried out altogether. A wide variety of systems and methods to achieve the said tasks can be found in related art. For example, U.S. Pat. No. 6,445,692 discloses blind adaptive algorithms that filter out multiuser and multi-path interference. However, it does not yield an estimate of the transmitted symbols nor it recovers the symbol synchronism. Similarly, U.S. Pat. Nos. 6,904,110 and 6,937,650 each discloses respective systems and methods for channel equalization but lack the means to recover the symbol synchronism. Therefore, all the said inventions require additional systems to perform all the necessary tasks that an optimal estimation of the transmitted symbols requires.

U.S. Pat. No. 5,282,225 discloses a similar channel equalization system. However, said invention employs a non-linear technique and a data symbol memory, making it different from the present one. A key element that differentiates the present invention from related art is the use of a waveform reconstruction filter that generates, from the symbol estimates, an interference-free replica of the received signal of interest. An adaptive filter updating subsystem utilizes said interference-free replica in order to compute the optimal response of the filters within the system.

Different algorithms for adaptive filtering can be implemented by the said filter updating subsystem (e.g., those described in S. Haykin, Adaptive Filter Theory, Prentice Hall, 2002). Some of the most common examples found in related art are the least mean squares (LMS) and the recursive least squares (RLS) algorithms. However, the present invention achieves optimal performance when the response of the filters within the system are updated at the symbol rate, instead of the sampling rate. The N-block LMS algorithm satisfies this requirement, but suffers from poor performance as compared to the RLS algorithm. The present invention also provides an adaptive algorithm, based on the RLS algorithm, which satisfies the requirement of updating the response of the filters at the symbol rate.

### SUMMARY OF THE INVENTION

The present invention is aimed at optimizing the performance of current systems while minimizing the amount of dedicated resources in the receiver. This invention provides systems, methods and algorithms, to be applied to a digitally modulated signal, by means thereof the functional tasks of interference mitigation, channel equalization, symbol synchronism recovery and symbol estimation are optimally carried out by a single system.

According to one embodiment, the system consists of a first filter, a symbol estimator, a second filter, and a filter updating subsystem to adjust the response of the first and second filters. The first filter operates on the input to the system, which is the demodulated signal, and acts as a channel equalization and symbol estimation filter. The output of the first filter is sampled at the symbol rate and feeds the symbol estimator. Symbol synchronization is automatically achieved by means of the filter updating subsystem, which conveniently introduces a delay in the response of the filters to optimize the instants at which the output of the first filter is sampled. Each of these samples constitutes a symbol estimate, on which a decision is made, and a conveniently formatted signal is fed into the second filter. Additionally, the gain of the first and second filters is automatically adjusted by the filter updating subsystem. However, an estimate of the average power output by the first filter may be needed to set the proper values of the thresholds used by the symbol estimator in the symbol decisions. The sequence of received symbols can be retrieved from the decisions made by the symbol estimator. The object of the second filter is to reconstruct the received signal, which is used by the filter updating subsystem to adjust the response of the first and second filters.

Other embodiments of the invention are set forth in part in its description, below, and in part, may be obvious from this description, or may be learned from the practice of the invention. Preferred algorithms for the adaptation of the responses of the filters are also described, without thereby the systems and methods described in the present invention be limited to such algorithms.

### BRIEF DESCRIPTION OF THE DRAWINGS

FIG. 1 is a schematic of an embodiment of the system.

FIGS. 2A and 2B describe an adaptation algorithm to be used by the filter updating subsystem (FUS) of FIG. 1

### DETAILED DESCRIPTION OF THE INVENTION

The broad descriptions disclosed herein provide detailed embodiments of the invention. However, the invention may be embodied in various and alternative forms and therefore, there is no intent that specific details should be limiting. Instead, the description herein serves as a basis for the claims and for teaching one skilled in the art to variously employ the present invention. Moreover, the present invention allows myriad ways of being implemented, either in software, as a specialized hardware, or a combination thereof. Similarly, all of the equations articulated herein can be reformulated in many equivalent forms, nevertheless leading to the same overall result.

The embodiments of the present invention are able to jointly solve the problems of interference mitigation, channel equalization, symbol synchronism recovery, and symbol estimation, related to the reception of digitally modulated signals. Because all these problems are jointly addressed by a single system, the performance (e.g., in terms of the bit error rate) of the system is optimized, while the total amount of resources utilized by its embodiments can be minimized. Therefore, the system improves both performance and resource efficiency as compared to current related art, which dedicates different systems to solve each of these problems separately.

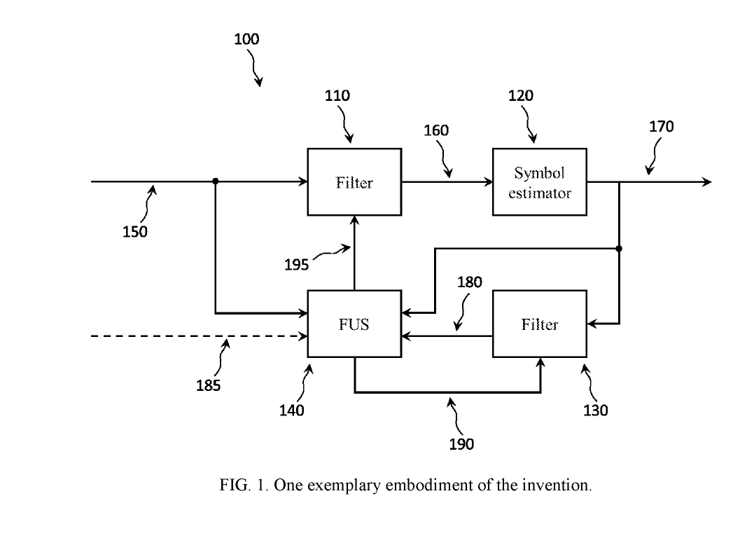

With reference to FIG. 1, an exemplary system 100 includes at least two filters 110, 130, one symbol estimator 120, and one filter updating subsystem (FUS) 140. The input signal 150 to the system is a digital signal, in general, consisting of real and imaginary parts. The input 150 is filtered by means of an estimation filter 110, which generates an estimation signal 160. The response of the estimation filter 110 is periodically updated using filter updates 195 generated by the FUS 140. Updating the estimation filter 110 is critical to achieve efficient channel equalization and interference mitigation, as well as symbol synchronization. The symbol estimator 120 computes the sequence of received symbols and generates the output signal 170, which is the output of the system 100. In a preferred embodiment, the estimation filter 110 is a decimating filter outputting at the symbol rate. Alternatively, the symbol estimator 120 periodically takes samples of the estimation signal 160, with a period equal to the inverse of the symbol rate. In each case, the symbol estimator 120 compares the sampled values to a set of thresholds in order to make a decision on the received symbol. For multilevel digital modulations, the optimal set of thresholds needs to be adjusted (scaled) according to the power of the estimation signal 160. In a preferred embodiment, when configured to receive multilevel signals, the symbol estimator 120 internally computes the average power of the estimation signal 160 and the set of thresholds is scaled accordingly. In an alternative embodiment, the symbol estimator 120 may consist of simply sampling the estimation signal 160, being the decisions on symbols taken in a subsequent system (not shown in FIG. 1) external to the system 100. In a preferred embodiment, the output signal 170 generated by the symbol estimator 120 consists of the sequence of estimated symbols. In addition to the estimation filter 110, the system 100 incorporates a reconstruction filter 130, which operates on the output signal 170 in order to generate a reconstructed signal 180, which is a clean reconstruction of the digitally modulated signal present in the input signal 150. In a preferred embodiment, the reconstruction filter 130 is an interpolating filter, which conveniently interpolates from the symbol rate (the sample rate of the output signal 170) to the sample rate of the input signal 150, so that the sample rates of the reconstruction signal 180 and the input signal 150 match. The system 100 mitigates any perturbation present in the input signal 150 by means of both the estimation filter 110 and the symbol estimator 120. As a result, the reconstructed signal 180 is a clean reconstruction of the digitally modulated signal present in the input signal 150. The responses of both the estimation filter 110 and the reconstruction filter 130 are periodically updated with their respective filter updates 195, 190, generated by the FUS 140. The FUS 140 computes the filter updates 190, 195 by comparison of the reconstructed signal 180 with a reference signal, which may be an external reference signal 185 (as indicated by the dashed arrow in FIG. 1), or may be equal to the input signal 150 (or a delayed version of it).

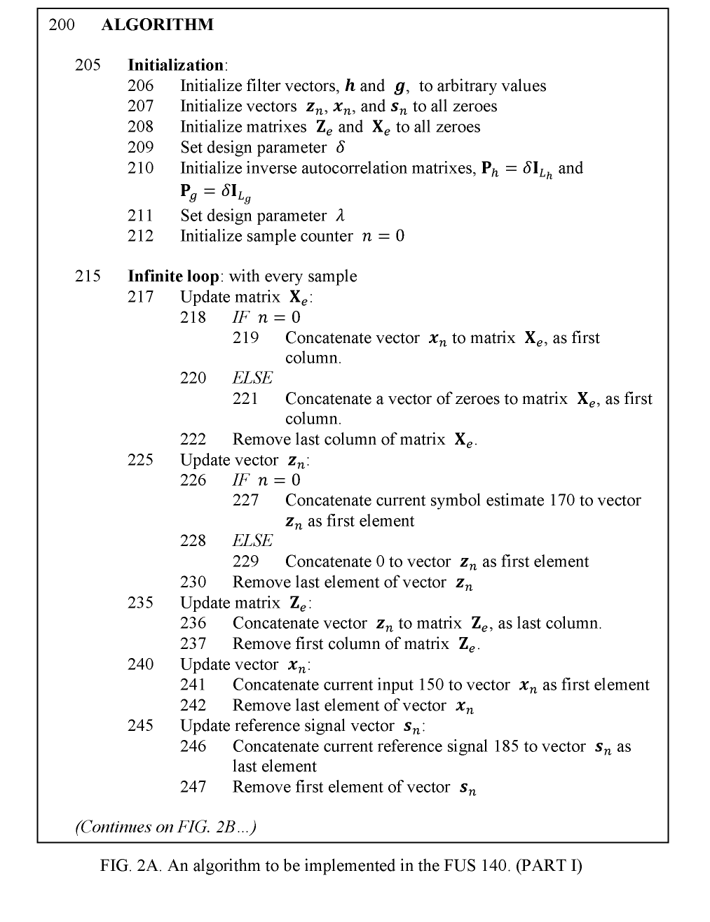

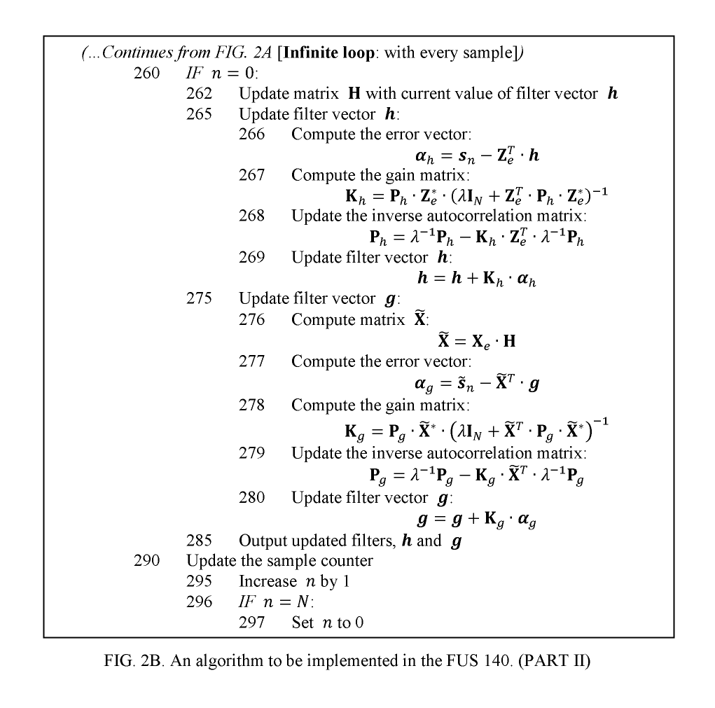

In a preferred embodiment, both the estimation filter 110 and the reconstruction filter 130 are of the finite impulse response (FIR) kind, and the FUS 140 computes the filter updates 190, 195 as described by the algorithm 200 described in FIG. 2A and FIG. 2B. In such an embodiment, the taps of the filters 110, 130 are updated by the recursive algorithm 200 at a rate equal to the symbol rate, instead of the sampling rate, thus preventing instabilities of the system 100. With reference to FIGS. 2A and 2B, vector h is a complex column vector with Lₕ elements corresponding to the taps of an FIR implementation of the reconstruction filter 130. Analogously, vector g is a complex column vector with L_{g} elements corresponding to the taps of an FIR implementation of the estimation filter 110. Vectors zₙ and xₙ, with lengths Lₕ and L_{g} respectively, are updated with the output signal 170 and the input signal 150, respectively, according to steps 225 and 240 of the algorithm 200. Vectors sₙ and \tilde{s}ₙ are complex column vectors with N elements, where N is the ratio between the sample rates of the input signal 150 and the output signal 170, which matches the symbol period. In one embodiment of the system 100, there is an external reference signal 185 which is used to update the reference signal vector sₙ according to step 245. In such a case, vector \tilde{s}ₙ=sₙ. In a different embodiment, the reference signal is generated internally from the input signal 150 as a delayed version of it, and the algorithm 200 is referred to as blind, in the sense that no additional external signal is required. In such a case, vector \tilde{s}ₙ=Zₑ^{T}·h. Matrixes Zₑ and Xₑ, each with dimensions Lₕ×N, and L_{g}×(Lₕ+N−1), respectively, are updated from vectors zₙ and xₙ, according to steps 235 and 217, respectively. Matrix H is a convolution matrix with dimensions (Lₕ+N−1)×N, which is built from filter vector h at step 262 according to the expression:

$$H = [ \begin{matrix}0 & 0 & 0 & … & 0 & 0 & h \\ 0 & 0 & 0 & … & 0 & h & 0 \\ 0 & 0 & 0 & … & h & 0 & 0 \\ ⋮ & ⋮ & ⋮ & ⋱ & ⋮ & ⋮ & ⋮ \\ 0 & 0 & h & … & 0 & 0 & 0 \\ 0 & h & 0 & … & 0 & 0 & 0 \\ h & 0 & 0 & … & 0 & 0 & 0\end{matrix} ]$$

Additional symbols used in the description of the algorithm 200 are the inverse autocorrelation matrix Pₕ with dimensions Lₕ×Lₕ, the inverse autocorrelation matrix P_{g}, with dimensions L_{g}×L_{g}, the identity M×M matrix I_{M}, the gain matrix Kₕ, with dimensions Lₕ×N, the gain matrix K_{g}, with dimensions L_{g}×N, and the error vectors αₙ and α_{g}, which are both column complex vectors with N elements. Both δ and λ are design parameters. In a preferred embodiment, δ will be set to a small value and λ close to, but less than unity. The adaptation algorithm 200 computes the filter updates only once every each N samples (when the sample counter n=0).

The adaptation algorithm 200 offers a performance superior to other well-known algorithms, such as the least mean squares (LMS) or the recursive least mean squares (RLS), and thereby constitutes a preferred embodiment. Moreover, the algorithm 200 can be modified to operate at the symbol rate by further simplification of the algebra. However, the system and method exemplified by the embodiment depicted in FIG. 1 is independent of the adaptation algorithm used, and therefore cannot be understood as limited to the use of the adaptation algorithm 200.

1. A method comprising:
(a) Estimating the symbols in a digitally modulated input signal by means of a symbol estimation filter and a symbol estimator,
(b) Generating a replica of the digitally modulated signal from the said symbol estimates by means of a waveform reconstruction filter,
(c) Using the error between the input signal and the said signal replica to update the response of the waveform reconstruction filter, and
(d) Using the error between the said signal replica and the output of the symbol estimation filter for a modified input signal to update the response of the said symbol estimation filter.

2. The method of claim 1, wherein an additional reference input signal is used to update the responses of both the symbol estimation filter and the waveform reconstruction filter.

3. A system comprising:
(a) A symbol estimation filter configured to process a digitally modulated input signal and jointly estimate the received symbols, equalize the channel and mitigate interfering signals,
(b) A symbol estimator configured to process the output of said symbol estimation filter and yield a symbol estimate,
(c) A waveform reconstruction filter configured to process the output of said symbol estimator and produce a clean replica of the said digitally modulated input signal, and
(d) A filter updating subsystem configured to process the input signal, the output of said waveform reconstruction filter, and the output of said symbol estimator, and to produce the updated responses of the symbol estimator filter and waveform reconstruction filter.

4. The system of claim 3, wherein the said symbol estimation filter and the said symbol estimator are jointly implemented as a single filter.

5. The systems of claims 3, and 4, wherein the said filter updating subsystem utilizes an additional reference input signal to yield the updated responses of the filters.

6. An adaptive filtering system comprising:
(a) Digital filter means in a receiver for joint symbol estimation, symbol synchronization, channel equalization and interference mitigation in accordance with the following recursive algorithm:
f(n):f(n+1)=f(n)+K(n)·α(n)
wherein K(n) is a gain matrix and α(n) is an error vector.
(b) The gain matrix K(n) is computed as:
K(n)=P(n−1)·X*(n)·(λI_{N}+X^{T}(n)·P(n·1)·X*(n))⁻¹
wherein P(n) is an inverse autocorrelation matrix and X(n) is a matrix built from the samples of the digital signal input to the filter or a linear transformation thereof.
(c) The inverse autocorrelation matrix P(n) is computed as:
P(n)=λ⁻¹P(n−1)−K(n)·X^{T}(n)·λ⁻¹P(n−1)
(d) The error vector α(n) is computed as:
α(n)=s(n)−X^{T}(n)·f(n)
wherein the vector s(n) is built from the samples of a reference signal.

7. The adaptive filtering system of claim 6 wherein said matrix X(n) is built from the coefficients of other filter within the system in addition to the samples of the digital signal input to the adaptive filter.
